(19) United States
(12) Patent Application Publication
(10) Pub. No.: US 2018/0055012 A1
(43) Pub. Date: Mar. 1, 2018

(54) TWO-PIECE FRICTION FIT TREAT DISPENSER

(71) Applicant: SWAG Company, Inc., San Diego, CA (US)

(72) Inventor: Cindy DeAngelis-Duffy, San Diego, CA (US)

(21) Appl. No.: 15/377,343

(22) Filed: Dec. 13, 2016

Related U.S. Application Data
(60) Provisional application No. 62/382,591, filed on Sep. 1, 2016.

(51) Int. Cl. A01K 15/02

(52) U.S. Cl. CPC A01K 15/025

(57) ABSTRACT

Described herein is a two-piece friction fit treat dispenser toy comprising a hollow exterior cylindrical portion and a hollow interior cylindrical portion, where the interior cylindrical portion forms a friction fit within the exterior cylindrical portion, and wherein the exterior cylindrical portion and interior cylindrical portion form openings for placement of edible treats for animals. The friction fit may be created by the placement of annular protrusions on an interior surface of the exterior cylindrical portion which are configured to abut against a corresponding set of annular protrusions on the exterior surface of the interior cylindrical portion. When the two pieces are in friction fit, one or more edible treats may be placed within openings created between the exterior cylindrical portion and interior cylindrical portion on either side of the annular protrusions and within the hollow openings.

### BACKGROUND

### Field of the Invention

The embodiments described herein are related to a treat dispenser toy, and more particularly to a two-piece friction fit treat dispenser toy with a friction fit ring and a plurality of openings for holding treats.

### Related Art

There are many treat dispenser toys on the market for animals which allow an edible treat to be placed in a cavity. These dispenser toys allow an animal to “play” with the treat dispenser toy by attempting to remove the treat either with their mouth, tongue or paws. However, there is a continuous desire to create dispenser toys which provide additional challenges for an animal when attempting to reach the treat, and which also provide for additional ways for the animal to play with the dispenser toy.

### SUMMARY

Embodiments described herein provide a two-piece friction fit treat dispenser toy comprising a hollow exterior cylindrical portion and a hollow interior cylindrical portion, where the interior cylindrical portion forms a friction fit within the exterior cylindrical portion, and wherein the exterior cylindrical portion and interior cylindrical portion form openings for placement of edible treats for animals. The friction fit may be created by the placement of annular protrusions on an interior surface of the exterior cylindrical portion which are configured to abut against a corresponding set of annular protrusions on the exterior surface of the interior cylindrical portion. When the two pieces are in friction fit, one or more edible treats may be placed within openings created between the exterior cylindrical portion and interior cylindrical portion on either side of the annular protrusions and within the hollow openings. The exterior cylindrical portion and interior cylindrical portion may also expand to a degree sufficient to help contain the edible treats within the openings. An animal such as a dog can play with the treat dispenser toy by pulling the two pieces apart in order to access the edible treats within the openings.

Other features and advantages of the present invention will become more readily apparent to those of ordinary skill in the art after reviewing the following detailed description and accompanying drawings.

### BRIEF DESCRIPTION OF THE DRAWINGS

The structure and operation of the present invention will be understood from a review of the following detailed description and the accompanying drawings in which like reference numerals refer to like parts and in which:

FIG. 1A is an image of a treat dispensing toy including a hollow exterior cylindrical portion with annular protrusions along an interior wall, and a hollow interior cylindrical portion with annular protrusions along an exterior wall, according to an embodiment of the invention;

FIG. 1B is a side-view image of the treat dispensing toy illustrating the interior cylindrical portion in friction fit with the exterior cylindrical portion, according to an embodiment of the invention;

FIG. 1C is a perspective-view image of the treat dispensing toy illustrating position of the exterior cylindrical portion and interior cylindrical portion prior to being fitted together, according to one embodiment of the invention;

FIG. 1D is a perspective-view image of the treat dispensing toy illustrating the interior cylindrical portion being fitted into the exterior cylindrical portion, according to one embodiment of the invention;

FIG. 1E is a perspective-view image of the treat dispensing toy illustrating the assembled configuration of the exterior cylindrical portion with the interior cylindrical portion fitted therein, according to one embodiment of the invention;

FIG. 1F is a perspective-view image of the treat dispensing toy with several edible treats positioned into openings of the treat dispensing toy, according to one embodiment of the invention;

FIG. 2A is a perspective-view illustration of the interior cylindrical portion illustrating two rows of annular protrusions along the exterior wall, according to an embodiment of the invention;

FIG. 2B is a side-view illustration of the interior cylindrical portion illustrating two rows of annular protrusions along the exterior wall, according to an embodiment of the invention;

FIG. 2C is a perspective-view illustration of the interior cylindrical portion illustrating a row of annular protrusions along an interior wall, according to an embodiment of the invention;

FIG. 3A is a perspective-view illustration of the exterior cylindrical portion illustrating a row of annular protrusions along the interior wall, according to an embodiment of the invention;

FIG. 3B is a side-view illustration of the exterior cylindrical portion, according to an embodiment of the invention;

FIG. 3C is a top-view illustration of the exterior cylindrical portion illustrating the row of annular protrusions along an interior wall, according to an embodiment of the invention;

FIG. 4A is a perspective-view illustration of a three piece treat dispensing toy illustrating a middle hollow cylindrical portion with a plurality of rows of annular protrusions along an exterior surface and a plurality of rows of annular protrusions along an interior surface, according to an embodiment of the invention;

FIG. 4B is an exploded view illustration of the three piece treat dispensing toy illustrating the outer cylindrical portion, middle cylindrical portion and interior cylindrical portion, according to one embodiment of the invention;

FIG. 4C is a bottom view illustration of the three piece treat dispensing toy in friction fit, according to one embodiment of the invention;

FIG. 5 is a side view illustration of an alternative embodiment of the treat dispensing toy showing an angular outer surface of one of the hollow portions, according to one embodiment of the invention; and

FIG. 6 illustrates an exemplary method of manufacturing the treat dispensing toy, according to one embodiment of the invention.

### DETAILED DESCRIPTION

Certain embodiments disclosed herein provide for two-piece friction fit treat dispenser toy comprising a hollow exterior cylindrical portion and a hollow interior cylindrical portion, where the interior cylindrical portion forms a friction fit within the exterior cylindrical portion, and wherein the exterior cylindrical portion and interior cylindrical portion form openings for placement of edible treats for animals. The friction fit may be created by the placement of annular protrusions on an interior surface of the exterior cylindrical portion which are configured to abut against a corresponding set of annular protrusions on the exterior surface of the interior cylindrical portion. When the two pieces are in friction fit, one or more edible treats may be placed within openings created between the exterior cylindrical portion and interior cylindrical portion on either side of the annular protrusions and within the hollow openings. The exterior cylindrical portion and interior cylindrical portion may also expand to a degree sufficient to help contain the edible treats within the openings. An animal such as a dog can play with the treat dispenser toy by pulling the two pieces apart in order to access the edible treats within the openings.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

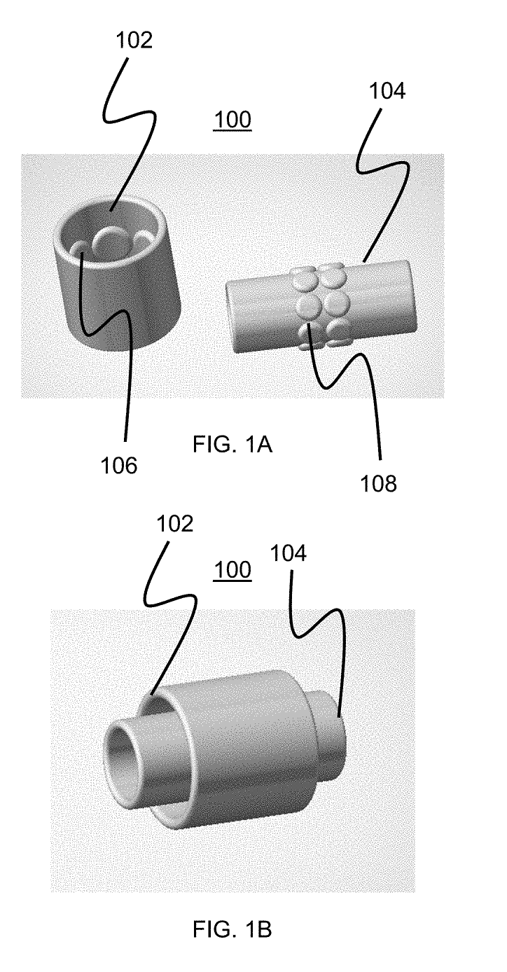

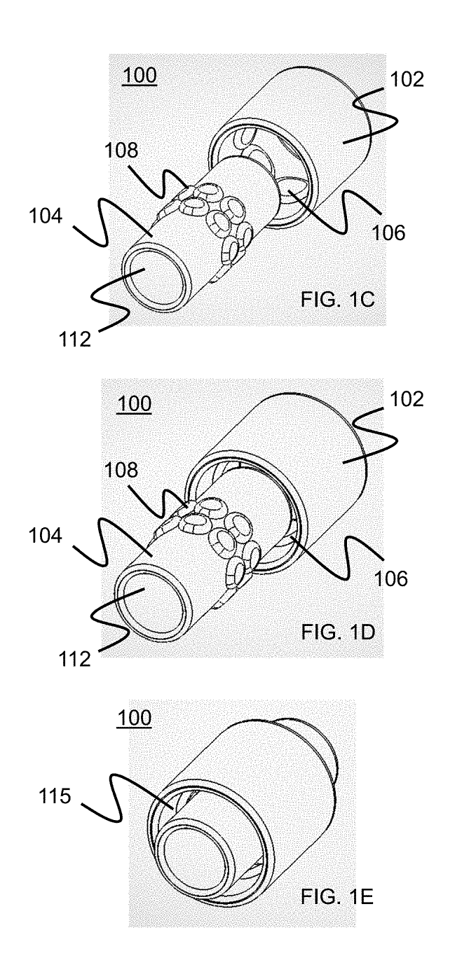

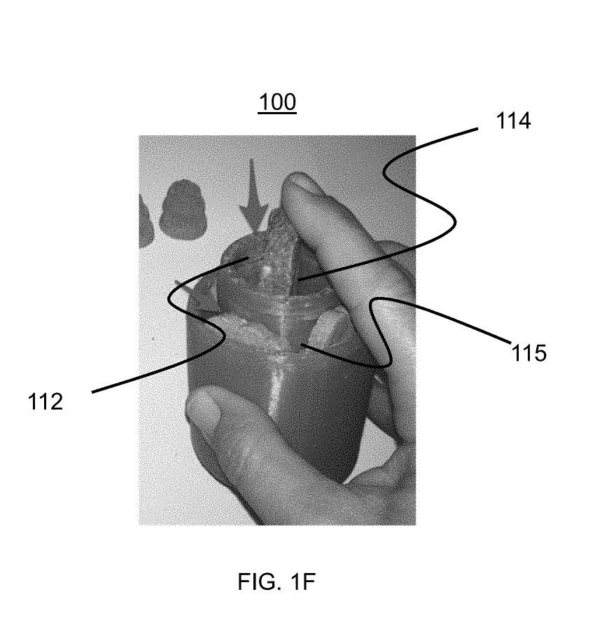

FIG. 1A illustrates one embodiment of a treat dispenser toy 100 in a disassembled configuration comprising an exterior cylindrical portion 102 and an interior cylindrical portion 104. The portions are both hollow, with the exterior cylindrical portion having a diameter which is larger than the diameter of the interior cylindrical portion such that the interior cylindrical portion fits within the exterior cylindrical portion. The interior cylindrical portion is configured to fit within the exterior cylindrical portion with a friction fit through the use of a plurality of interior annular protrusions 106 placed on an interior surface of the exterior cylindrical portion 102 which correspond to a plurality of external annular protrusions 108 located on an exterior surface of the interior cylindrical portion 104.

FIG. 1B illustrates a side view illustration of the treat dispenser toy 100 in an assembled configuration, where the interior cylindrical portion 104 has been fitted into the exterior cylindrical portion 102 using the friction fit previously described. The interior cylindrical portion 104 may be inserted or removed from either opening of the exterior cylindrical portion 102. As illustrated in FIG. 1B and throughout the drawings, the interior cylindrical portion 104 may also be longer than the exterior cylindrical portion 102 such that it is easier to pull the interior cylindrical portion 104 apart from the exterior cylindrical portion 102.

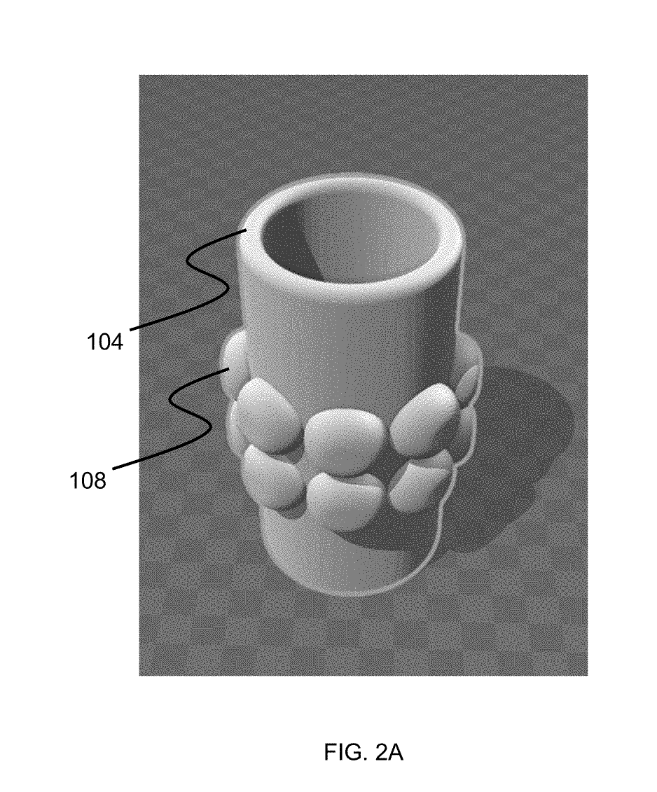

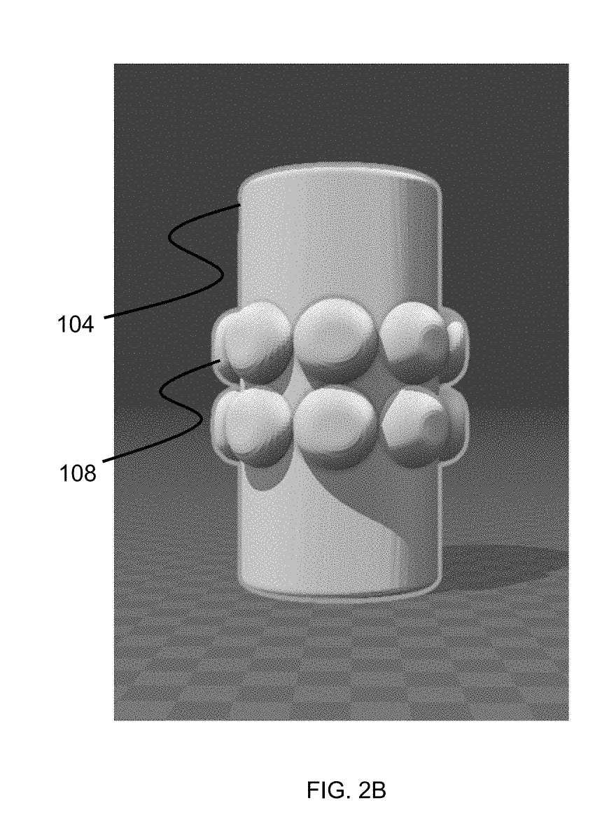

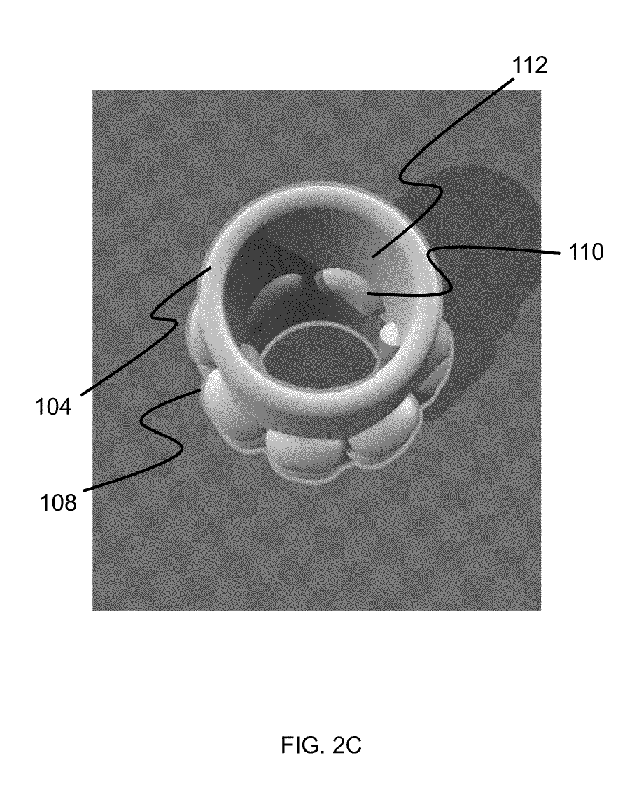

FIGS. 1C-1E are top perspective view illustrations of the treat dispenser toy 100 as it is being assembled, showing the interior cylindrical portion 104 being inserted into the exterior cylindrical portion 102, with FIG. 1C illustrating the portions lined up, FIG. 1D illustrating the interior cylindrical portion 104 being inserted into the exterior cylindrical portion 102, and FIG. 1E illustrating the final assembled configuration with the interior cylindrical portion 104 fitted into the exterior cylindrical portion 102. These figures illustrate the friction fit between the interior annual protrusions 106 and exterior annual protrusions 108 of the respective exterior cylindrical portion 102 and interior cylindrical portion 104, which form a gap or opening 115 between the exterior cylindrical portion and interior cylindrical portion 104, as shown in FIG. 1E. The opening 115 is configured to retain one or more treats, as shown below in FIG. 1F. In one embodiment, an additional set of interior annual protrusions (see FIG. 2C) is located on an interior surface of the interior cylindrical portion 104. This additional set of interior annual protrusions may be positioned to retain one or more edible treats within a hollow center cylindrical core 112.

FIG. 1F illustrates the treat dispenser toy 100 with a plurality of treats 114 placed within the center cylindrical core 112. The treats may also be placed within the opening 115 that is formed between the exterior cylindrical portion 102 and interior cylindrical portion 104, as shown here and in FIG. 1E. The exterior cylindrical portion and interior cylindrical portion may also expand to a degree sufficient to help contain the edible treats within the openings. Depending on the size and consistency of the treat, it may be more difficult for an animal to retrieve the treat. In the embodiment illustrated in FIG. 1F and 1D, the treat dispenser toy 100 can hold up to 10 small treats and 2 large treats, although this number is simply exemplary and not limiting in the minimum or maximum number of treats that may be used.

The overall size and dimensions of the treat dispenser toy may vary widely depending on the intended user, such as a small dog, large dog, or a large mammal such as a horse. In one embodiment, the treat dispenser toy in FIG. 1F has an interior cylindrical portion approximately 148 millimeters (mm) in height with an outer surface radius of approximately 48 mm and an inner surface radius of approximately 37 mm. The exterior cylindrical portion has a height of approximately 75 mm with an outer surface radius of approximately 75 mm and an interior surface radius of approximately 64 mm. The radial measurements exclude the protrusions. In one embodiment of a smaller treat dispenser, an interior cylindrical portion is approximately 81 millimeters (mm) in height with an outer surface radius of approximately 32 mm and an inner surface radius of approximately 25 mm. The exterior cylindrical portion has a height of approximately 50 mm with an outer surface radius of approximately 50 mm and an interior surface radius of approximately 43 mm. These examples are non-limiting and included only to show representative proportions of the interior and exterior cylindrical portions.

FIG. 2A is a perspective view illustration of the interior cylindrical portion 104 more clearly illustrating the external annular protrusions 108 in the form of two rows of adjacently-positioned circular shapes extending annularly around the exterior surface. While the protrusions may take the circular shapes illustrated herein, numerous other shapes may be utilized, such as squares, triangles or any polygonal shape. Instead of a row of individually-shaped protrusions, in one embodiment (not illustrated) a single solid circumferential band protrusion may be used instead of the individual-shaped protrusions. Additionally, instead of a row of continuous protrusions, the protrusions may be spaced apart such that only a few protrusions are utilized. These varying patterns and shapes of protrusions will each provide varying amounts of friction fit between the exterior cylindrical portion and interior cylindrical portion which may be useful for varying types of uses by animals of different sizes and capabilities, or where different types of treats are inserted and have different requirements for adequate retention within the openings.

Furthermore, although two rows of protrusions are illustrated herein, only one row may be used, while in other cases, more than two may be used. The protrusions aid in keeping the exterior cylindrical portion and interior cylindrical portion connected by providing a secure friction fit, but the shape and design of the protrusions also provide additional stability and durability to the portions themselves, which is useful when the two portions are pulled apart and played with separately. Furthermore, the placement of the protrusions at certain positions along the length of the portions is designed to prevent the treats from being inserted too deep within the openings so that an animal can more easily reach the treat without too much difficulty.

FIG. 2B illustrates the interior cylindrical portion 104 from a side view, showing the depth and shape of the external annular protrusions 108. The rounded shapes of the protrusions 108 provide for an easier frictional fit between the two portions as they are fitted together, and the shape and surface area of the protrusions may be altered in order to adjust the friction fit for a desired use. FIG. 2C is a top perspective view illustration of the interior cylindrical portion 104, showing the hollow center cylindrical core 112 with the third set of interior annular protrusions 110.

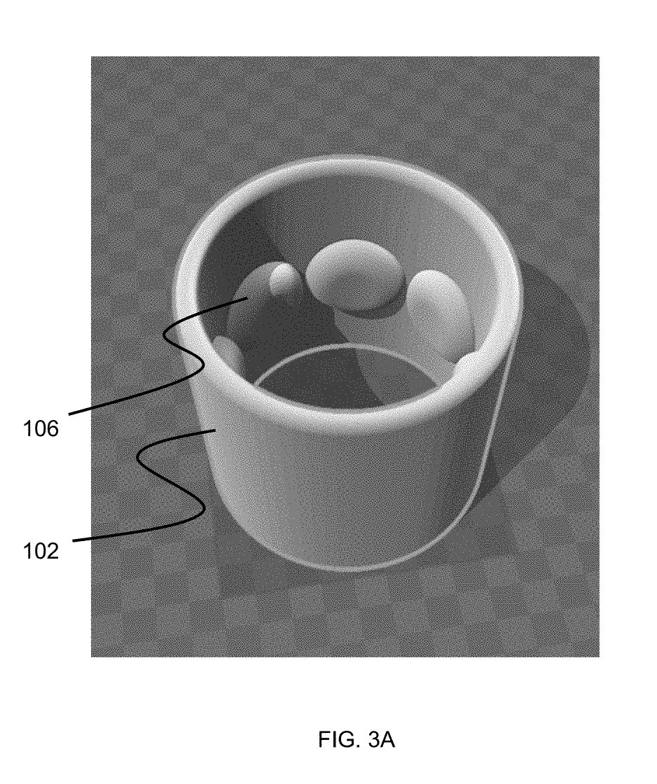

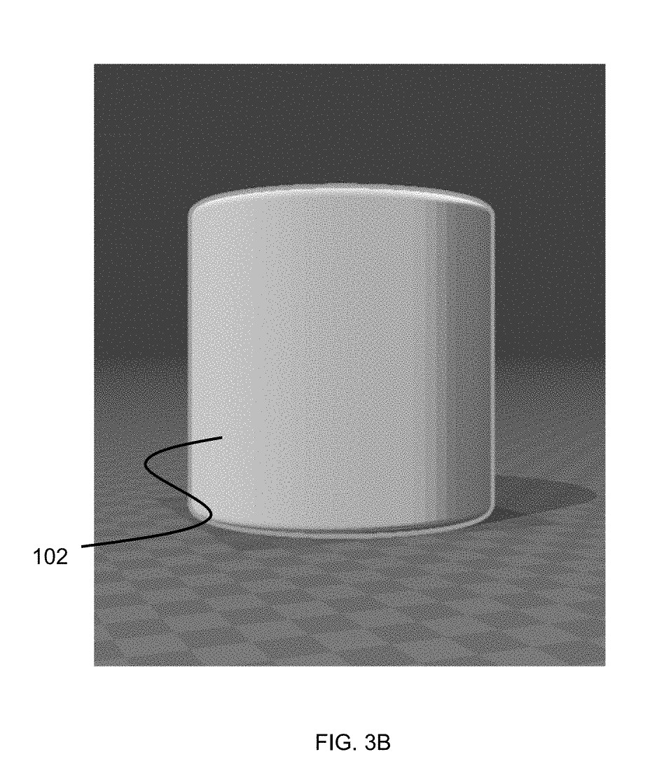

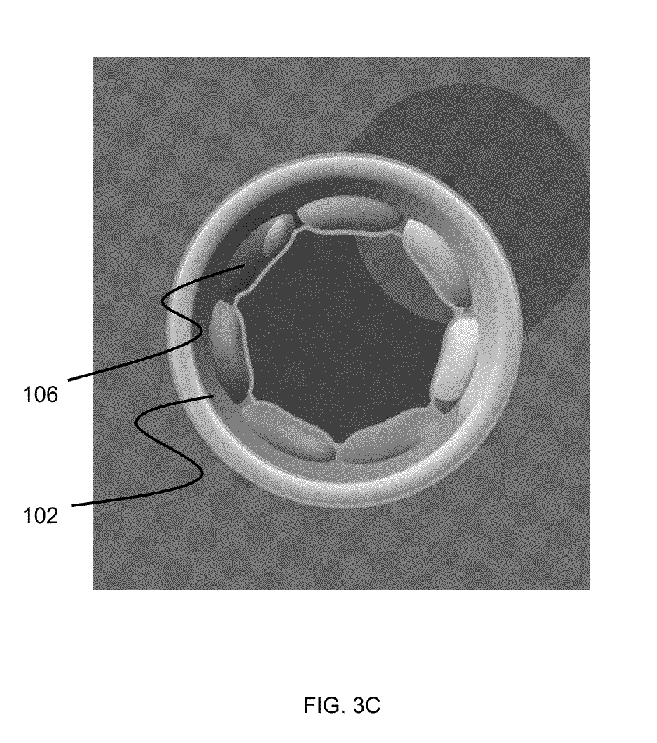

FIG. 3A is a perspective view illustration of the exterior cylindrical portion 102, illustrating the first interior annular protrusions 106 positioned around the interior surface of the exterior cylindrical portion 102. FIG. 3B is a side view illustration of the exterior cylindrical portion showing the smooth surface of the exterior cylindrical portion 102. FIG. 3C is a top down view illustration showing the relative thickness of the first interior annular portions 106 and the corresponding opening generated along the interior surface of the exterior cylindrical portion.

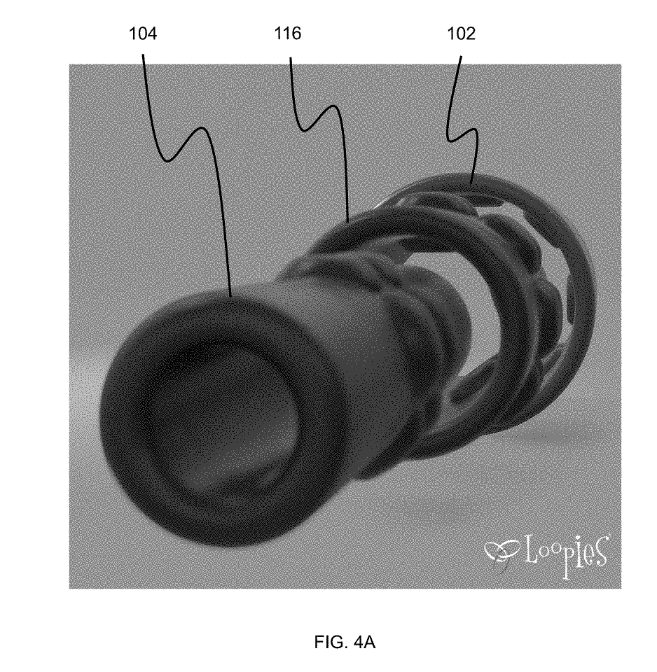

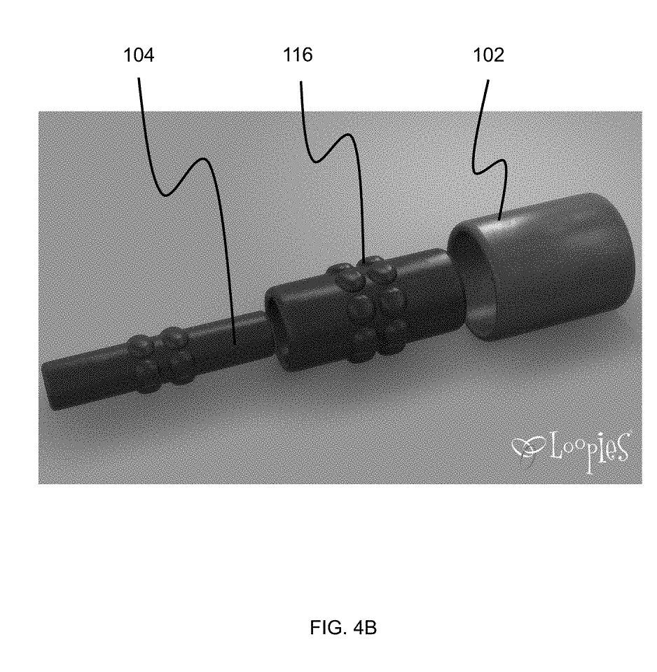

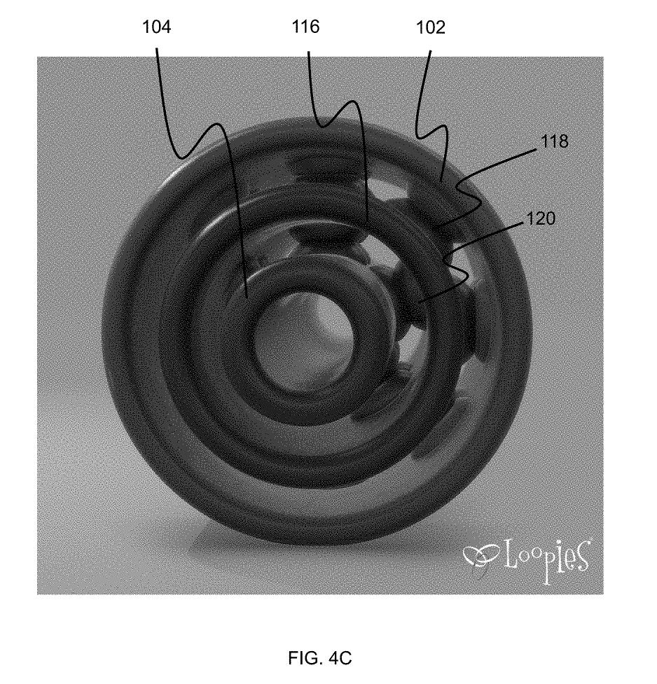

In another embodiment, more than two portions may be utilized in a treat dispenser toy to provide additional openings and a further challenge for an animal to remove all of the portions. FIG. 4A illustrates one embodiment of a three piece treat dispenser toy showing an interior cylindrical portion 104, a middle cylindrical portion 116 and an exterior cylindrical portion 102. The middle cylindrical portion 116 may include middle exterior annular protrusions 118 and middle interior annular protrusions 120 which interface with respective protrusions on the exterior cylindrical portion 102 and interior cylindrical portion 104. FIG. 4B further illustrates an exploded view of the treat dispenser toy showing the varying diameters and lengths of each portion and how all three portions can be fit one inside another to create a single cylindrical treat dispenser toy, with the interior portions being longer than the outer portions. FIG. 4C illustrates a bottom perspective view of the three piece treat dispenser toy in the assembled configuration with the smaller middle cylindrical portion 116 and interior cylindrical portion 104 inside of the exterior cylindrical portion 102. More specifically, the middle exterior annular protrusions 118 are in friction fit with the interior annular protrusions 106 on the exterior cylindrical portion 102, while the middle interior annular protrusions 120 are in friction fit with the external annular protrusions 108 on the interior cylindrical portion 104.

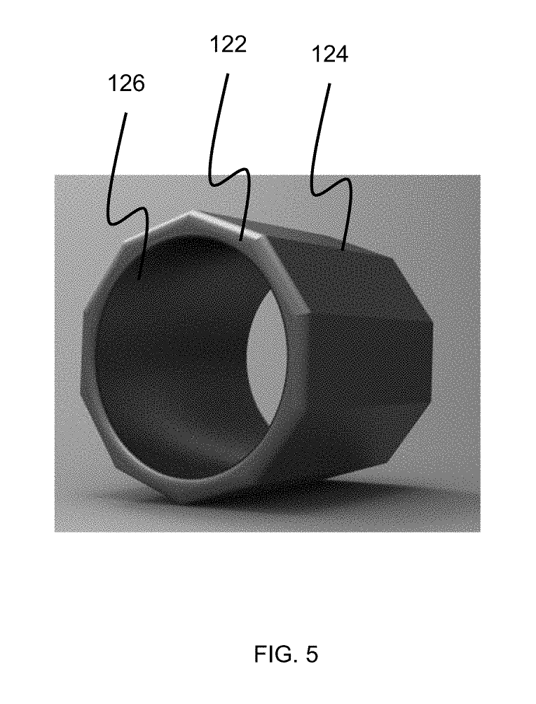

FIG. 5 is a perspective view illustration of a decagon-shaped cylindrical portion 122, according to an alternate embodiment of the invention. In this embodiment, the exterior surface 124 is a decagon, while the interior surface 126 is still rounded, although it is possible that the interior surface also have a polygon shape similar to that of the exterior surface 124. The treat dispenser toy could therefore take on any polygon shape and still function similarly to the cylindrical-shaped portions disclosed above. In another embodiment, the shapes of the portions may be different from one another, such as a square-shaped interior portion and a cylindrical-shaped exterior portion. The use of differing shapes could create different-sized openings between the two portions that could be used to insert different sizes and shapes of treats.

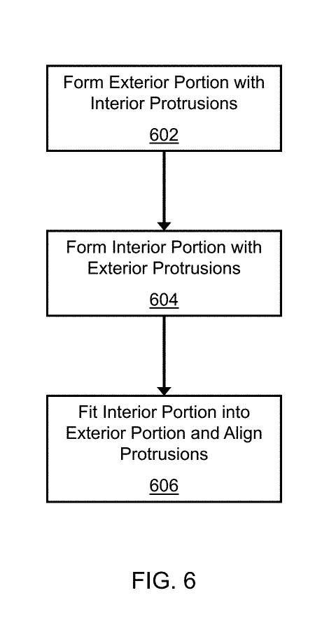

FIG. 6 illustrates an exemplary method of manufacturing the treat dispensing toy, according to one embodiment of the invention. In step 602, a hollow exterior portion is fabricated with an interior protrusion on an interior surface thereof, and in step 604, a hollow interior portion is fabricated with an exterior protrusion on an exterior surface thereof. In step 606, the treat dispensing toy is assembled into its assembled configuration by fitting the interior portion into the exterior portion such that the interior protrusion make frictional contact with the exterior protrusion.

In one embodiment, the treat dispenser toy may be formed from a rubber material, although a plastic or other polymer such as TPR or TPE could also be used. The material may be flexible or rigid. The treat dispenser toy should be formed from a material that provides an adequate level of friction between the exterior and interior cylindrical portions in order to keep them together when the animal is not pulling on the portions, but to also allow them to be pulled apart when a sufficient force is applied by the animal to pull on one of the portions. Different levels of hardness and thickness of the selected material may be utilized depending upon the amount of force expected to be applied to the portions, and the portions may be specifically configured for different levels of force, if, for example, one treat dispenser toy is designed for a small dog while another is designed for a large dog or other large animal. In one embodiment, the opening between the exterior cylindrical portion and interior cylindrical portion may be approximately 0.25 inches. However, the size of the opening may vary considerably depending on the type of treat to be inserted therein or the type of animal for which use of the toy is intended.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

What is claimed is:

1. A treat dispensing apparatus, comprising:
a hollow exterior portion with a plurality of interior protrusions positioned along an interior surface; and
a hollow interior portion with a plurality of exterior protrusions positioned along an exterior surface;
wherein the interior portion fits into the hollow exterior portion such that the interior protrusions and the exterior protrusions form a friction fit; and
wherein the friction fit of the interior protrusions and exterior protrusions create openings between the exterior portion and interior portion.

2. The treat dispensing apparatus of claim 1, wherein the interior protrusions and exterior protrusions are aligned in a row around their respective surfaces.

3. The treat dispensing apparatus of claim 1, wherein the interior protrusions and exterior protrusions have a rounded shape.

4. The treat dispensing apparatus of claim 1, wherein the interior protrusions and exterior protrusions form a solid band around their respective surfaces.

5. The treat dispensing apparatus of claim 1, wherein the interior protrusions and exterior protrusions form a plurality of rows.

6. The treat dispensing apparatus of claim 1, wherein the hollow exterior portion and hollow interior portion are cylindrical-shaped.

7. The treat dispensing apparatus of claim 1, wherein the hollow exterior portion and hollow interior portion are square-shaped.

8. A method of manufacturing a treat dispensing apparatus, comprising:
forming a hollow exterior cylindrical portion with a plurality of interior protrusions positioned along an interior surface;
forming a hollow interior cylindrical portion with a plurality of exterior protrusions positioned along an exterior surface; and
fitting the interior cylindrical portion into the hollow exterior cylindrical portion such that the interior protrusions and the exterior protrusions form a friction fit; and
wherein the friction fit of the interior protrusions and exterior protrusions create openings between the exterior cylindrical portion and interior cylindrical portion.
